(19) United States
(12) Patent Application Publication
(10) Pub. No.: US 2011/0071924 A1
(43) Pub. Date: Mar. 24, 2011

(54) SYSTEM AND METHOD FOR PROCESSING CONSUMER TRANSACTIONS USING A CENTRAL SERVER AND A MOBILE PROCESSOR

(75) Inventors: John G. DESMOND, Fairfield, CT (US); Robert A. Augelli, Prospect, CT (US); Thomas J. Niglio, Milford, CT (US); Douglas B. Quine, Bethel, CT (US); Thomas J. Foth, Trumbull, CT (US)

(73) Assignee: Pitney Bowes Inc., Stamford, CT (US)

(21) Appl. No.: 12/562,240

(22) Filed: Sep. 18, 2009

(51) Int. Cl. G06Q 30/00; G06F 17/30

(52) U.S. Cl. 705/27.1; 707/E17.107

(57) ABSTRACT

A system and method for obtaining an item includes retrieving consolidated data concerning an item from a provider infrastructure, the consolidated data including data elements from a source of the item and data elements concerning a mobile user of the provider infrastructure. Verifiable authorization is retrieved from the provider infrastructure for the mobile user of the provider infrastructure to obtain the item from the source of said item consistent with the consolidated data. The consolidated data may have various data elements specific to the source of the items such as price offers, rebates, incentives and discounts and location of the item and various data elements specific to the mobile user such as gift certificates, loyalty programs, buyers' group participation and location of the mobile user in relation to the specific source. The verifiable authorization from said provider infrastructure is displayed on a device for said mobile user of said provider infrastructure to obtain the item from the source of the item consistent with the consolidated data. If a purchase decision is made, the system and method for obtaining an item may also include retrieving payment verification from the provider infrastructure for the item from the source of the item. This payment verification is consistent with the consolidated data and by a preselected method of payment by the mobile user of the provider infrastructure. The provider infrastructure is updated with data related to the mobile user of the provider infrastructure and the source of the item.

### TECHNICAL FIELD

The illustrative embodiments of the invention disclosed in the present application relate generally to systems and methods for obtaining an item and, more particularly, to methods and systems for obtaining an item that interconnects user, vendor, manufacturer and provider networks and infrastructures in a manner which obtains, stores and consolidates stored data elements concerning an item including user specific and source specific data elements and facilitates payment and payment verification for the item.

### BACKGROUND

Various systems and services have been developed to assist consumers in making purchases that compare prices of various sources for an item including cost tax and shipping as well as organizing loyalty card and recall information for use on cellular devices. This is to assist the consumer in the decision making process. Examples of such systems include One-click purchasing, Paypal, Google Checkout, Bill Bridge, Price Line, Buying Cards and others such as those of Froogle, Amazon, eDealinfo, Bing, eBay and the mycardstar internet offering of Card Star. Once a purchasing decision is made, a consumer may pay for the item over the Internet by a credit card, in-store by a credit card at an credit card check out terminal or by other means.

Even with systems such as those described above, consumers do not have a comprehensive system to obtain, organize and integrate relevant information stored in separate networks. Consumers still make purchase decisions without full knowledge of the final price for a given item delivery date. Consumers have no way of naming their price for general goods and services, or to receive quantity pricing and bid offers from vendors. Consumers have no centralized solution to manage their private contact information which may change over time nor current preferred secure methods of payment. Additionally, consumers have no centralized solution to manage purchase-related information such as private vs. business-related nor system to implement post purchase activities such as price guarantees and warranty benefits.

While the above systems provide some benefits to consumers in making purchasing decisions, they do not provide a comprehensive method or system for storing, organizing, communicating information relevant to obtaining an item nor verifying or facilitating activities before and after obtaining an item. Thus it is a desirable to provide a comprehensive system and method for obtaining an item.

### SUMMARY

It has been discovered that a system and method that interconnects user, vendor, manufacturer and provider networks and infrastructures can be implemented such that it that obtains, stores and consolidates stored data elements concerning an item including user specific and source specific data elements and facilitates payment and payment verification for such item.

It is an object of certain embodiments to provide a system and method that interconnects networks and infrastructures in a manner which consolidates and organizes both user specific and source specific data elements concerning an item. For example, user specific item data from a specific source could be associated with a particular pricing or procurement terms package in a time-based promotional model or otherwise and could be based upon specific dynamic user location for a mobile user.

It is a further object of certain embodiments to provide a system and method that interconnects networks and infrastructures in a manner which consolidates and organizes both user specific and source specific data from various sources based on time and location.

It is yet another object of certain embodiments to provide a system and method that interconnects networks and infrastructures in a manner which consolidates and organizes both user specific and source specific data based on activities prior to and subsequent to obtaining an item.

It is still a further object of certain embodiments to provide a system and method that interconnects plural users, vendors, manufactures and provider networks and infrastructures in a manner which consolidates and organizes both user specific and source specific data based on activities prior to and subsequent to obtaining an item to enhance the capability of the various entities involved in the process of manufacturing, selling, stocking transporting and providing services based on activities prior to and subsequent to items being obtained by users.

A method for obtaining an item according to the present application includes the steps of retrieving consolidated data concerning an item from a provider infrastructure, the consolidated data having data elements from a source of the item and data elements concerning a user of the provider infrastructure. Verifiable authorization is retrieved from the provider infrastructure for the user of the provider infrastructure to obtain the item from the source of the item consistent with the consolidated data. The verifiable authorization from the provider infrastructure is displayed on a device for the user of said provider infrastructure to obtain the item from the source of the item consistent with the consolidated data. The authorization may include verifying specific user access to a particular pricing or procurement terms package (price, delivery date, packaging, etc.) based upon specific dynamic user location for a mobile user.

In accordance with a feature of the present application, the method for obtaining an item embodying the present invention includes the further steps of retrieving payment verification from the provider infrastructure for the item from the source of said item consistent with the consolidated data by a preselected method of payment by the user of the provider infrastructure and updating the provider infrastructure with data related to the user of the provider infrastructure and the source of the item.

A system for obtaining an item according to the present application includes a provider infrastructure with a server and associated server memory having stored therein data elements relating to a source of an item and data elements relating to a user of the provider infrastructure, and operable to consolidate data stored therein. The consolidated data includes data elements from the source of the item and data elements concerning the user of the provider infrastructure. A bidirectional communications link connects the provider infrastructure and the user of the provider infrastructure. A bidirectional communications link connects the provider infrastructure and the source of the item. The provider infrastructure is operable to generate verifiable authorization for the user of the provider infrastructure to obtain the item from the source of the item consistent with the consolidated data. The provider infrastructure is also operable to communicate to the user of the provider infrastructure over the bidirectional communications link connecting the provider infrastructure and the user of said provider infrastructure the verifiable authorization for the user of the provider infrastructure to obtain the item from the source consistent with the consolidated data.

### DESCRIPTION OF THE DRAWINGS

The accompanying drawings, which are incorporated in and constitute a part of the specification, disclose illustrative embodiments of the present application, and together with the general description given above and the detailed description of the embodiments given below, serve to explain principles of the invention. As shown throughout the drawings, like reference numerals designate like or corresponding parts in the various figures.

FIGS. 1A and 1B is a block diagram of a system embodying the present invention that interconnects user, vendor manufacturer and provider networks and infrastructures in a manner which obtains, stores and consolidates stored data elements concerning the item including user specific and source specific data elements and facilitates payment and payment verification for an item;

FIGS. 2-8 are diagrammatic representation of a device suitable to be used when interconnecting to the system shown in FIGS. 1A and 1B to access and employ various features of the system shown in FIGS. 1A and 1B;

FIGS. 9A and 9B is a detailed flow chart of the operation of the system show in FIGS. 1A and 1B;

FIG. 10 is a flow chart of the of the vendor registration process; and,

FIG. 11 is a flow chart of the manufacturer registration process.

### DETAILED DESCRIPTION

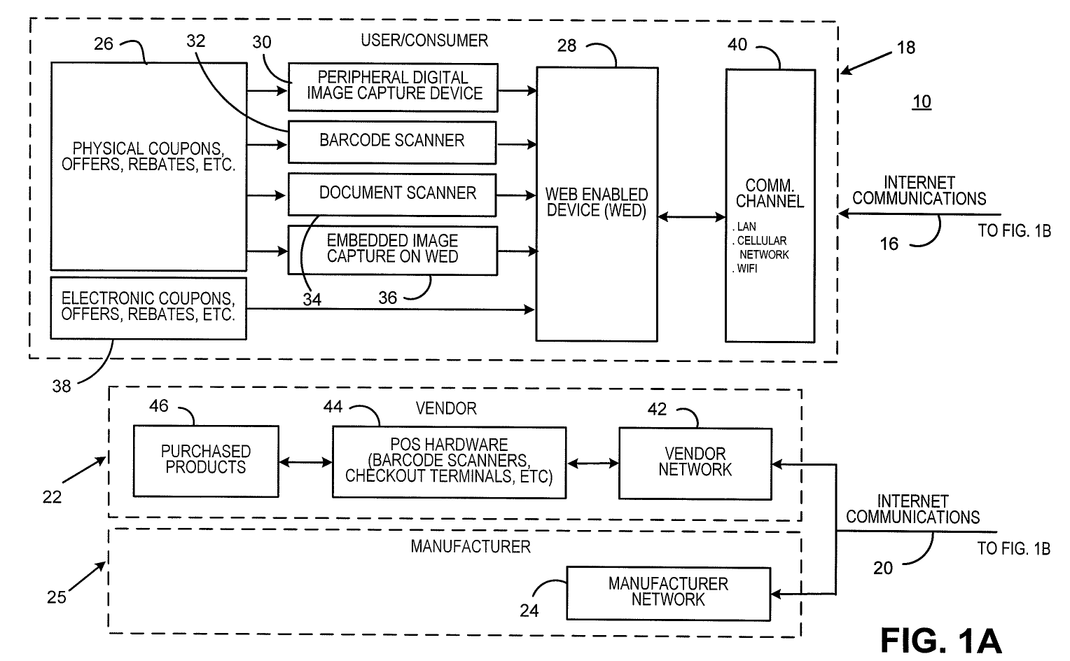

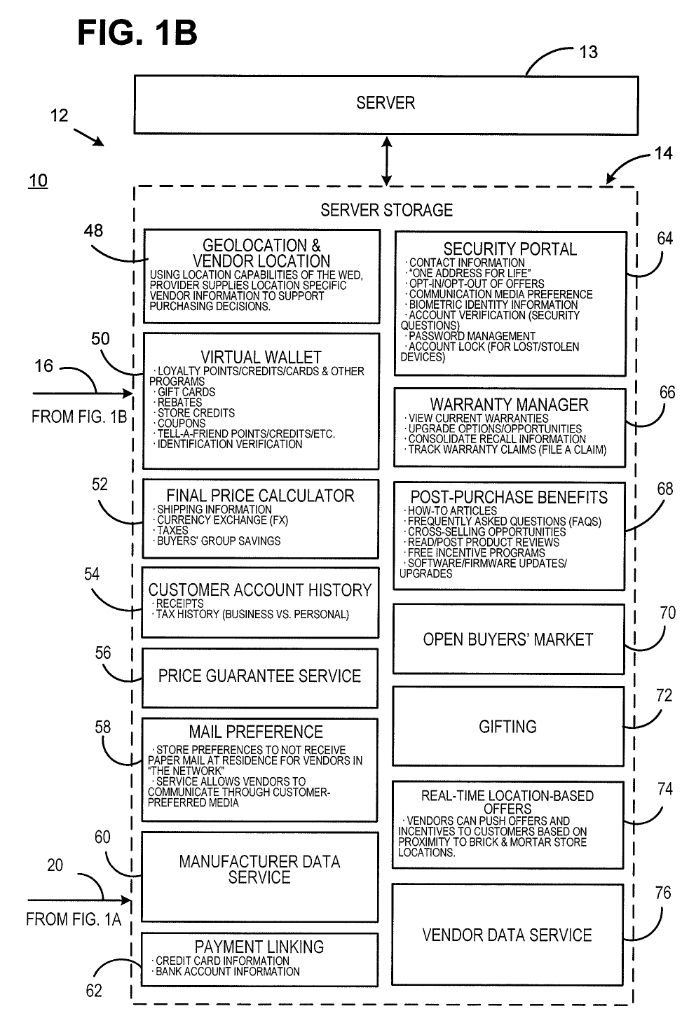

Reference is now made to FIGS. 1A and 1B. A system 10 for obtaining an item includes a provider infrastructure 12 including a server 13 and server storage 14. Various peripheral related hardware associated with the server 13 and server storage 14 is not shown. The provider infrastructure 12 communicates, for example, via the internet over a bidirectional communication link 16 with a user and/or a consumer shown generally at 18, and over a bidirectional communications link 20, again such as the internet, with both a vendor network and infrastructure 22 and a manufacturer network 24. The provider infrastructure is the software and hardware that which supports and enables the operation of the system shown in the various figures. The user and/or the consumer are hereinafter interchangeably referred to as the consumer or the user. However, the user may or may not be a consumer.

Referring to the user and/or consumer 18, physical coupons, offers, rebates and the like available to the user and/or consumer shown at 26 are entered by the user and/or consumer into a web enabled device 28. The web enabled device may be a PC (personal computer) with an IP (internet protocol) based location or user entered address. The web enabled device may also contain a GPS (global position system) enabled capability such as an iPhone type device or a Blackberry type device and the like.

The physical coupons, offers or rebates 26 may be printed documentation with UPC (universal product code) barcodes or other forms of identifications. The user enters these coupons, offers and rebates via one of a variety of type devices such as a peripheral digital image captured device 30, a barcode scanner 32, a document scanner 34 or a web enabled image capture capability on the web enabled device at 36. Electronic coupons, offers or other rebates shown at 38 received via the provider network infrastructure 12 or otherwise may be entered directly into the web enabled device 28. The web enabled device is connected to a communications channel 40 to facilitate communications over the bidirectional communications link 16 to the provider infrastructure.

Referring to the manufacturer network 24, the manufacturer network 24 communicates over the communication link 20 to provide various data and information which will be described hereinafter to the provider infrastructure and to receive from the provider infrastructure various information. In like manner, the vendor network and infrastructure 22 communicates over the communications link 20 to provide and receive various information to the provider infrastructure 12.

The vendor network and infrastructure 22 includes a vendor network 42 which communicates with the other portions of the vendor operation such as POS (point of sale) hardware 44 at various vendor stores and the interaction of the POS hardware 44 with the purchase of specific products that is, items, at 46. These purchased items typically have a UPC barcode or other form of electronic identification which is scanned at the point of sale hardware 44.

Referring again to the provider infrastructure server storage 14, various data elements concerning the vendor, manufacturer and the user are stored for subsequent consolidation and communication to, as needed, the user 18, the vendor 22 and the manufacturer 25. This includes stored geolocation and vendor location data 48. This type of stored data uses location capability of web enabled device and other similar devices of the user as well as provider supplies location and specific vendor information to support purchasing decisions. This data enables a purchasing decision to based, in part, on the current location of the mobile user and location of the item to be obtained and also enables the computation of cost and time related to the distances involved and locations. For example, an item located in a particular facility may involve long distance driving with tolls versus being mailed from a different vendor and the associated costs can be analyzed. For example, user specific item data from a specific source could be associated with a particular pricing or procurement terms package in a time-based promotional model or otherwise and could be based upon specific dynamic user location for a mobile user. The authorization may include verifying specific user access to a particular pricing or procurement terms package (price, delivery date, packaging, etc.) based upon specific dynamic user location for a mobile user. The dynamic location varies and the mobile user will have a present location at any time and recent location data associated with the user. For example, when a purchase transaction is initiated, the authorization data includes a recent location data point associated with the point in time that the purchase authorization request is made.

The server also stores at 50 what constitutes a virtual wallet providing user value information concerning specific items and specific vendors and manufacturers. These virtual wallet data elements can include loyalty points, loyalty credit, loyalty cards and other loyalty programs, gift cards, rebates, store credits, various types of coupons, tell-a-friend points, credits, programs and identification verification. The virtual wallet provides identification verification by utilizing stored data related to the user to provide a verifiable identification of the user for use by a given entity such as a vendor or other enterprise such as by the POS hardware 44.

At 52 a final price calculator stores various information such as shipping information, currency exchange rates, taxes, via group savings and the like. Customer account history is stored at 54. This includes information concerning receipts, tax history such as business versus personal purchases and other similar type information.

At 56 price guarantee service information is stored. This information provides the data for automatically receiving credits or other defined value over defined time frames for each vendor including vendor parameters for programs such price guarantee offers. Mail preference data is stored at 58. This data includes preferences regarding a user's desire to receive or not receive paper mail from vendors or manufacturers in the provider infrastructure network and services that allows the vendors to communicate to the consumer 18 through preferred media. At 60 manufacturer data services are stored. This includes loyalty incentives provided directly to the consumer for using or purchasing a given manufacturer's products. This is a manufacturer service and that enables the manufacturer through the bidirectional communication link 20 to access data related to the particular manufacturer's product and users and vendors that deal with such products. This enables a manufacturer to target specific consumers and/or vendors to provide and/or modify various incentive programs. The manufacturer data service 60 for manufacturers is similar to the vendor data services 76 for vendors hereinafter described.

At 62 payment linking information is stored. This includes information such as credit card information, bank account information and the like and also payment preferences for each particular user. At 64 security portal information is stored. This stores data related to how a user wants to be contacted and includes information and data elements such as contact information and one address for life access wherein a specific contact methodology is employed and utilized by the provider infrastructure to assist the consumer where the consumer may frequently change locations. The stored data may also relate to opt-in and opt-out of various offers and also to communication media preferences, biometric identity information, account verification, such as security questions and password management and account locking where a stolen or lost account card or device occurs. At 66 warranty manager data is stored. This includes current warranties related to the user, upgrade options and opportunities, consolidated recall information, and the ability to track warranty programs, file a warranty claim or track warranty claims.

At 68 post purchase benefits are stored. These relate to various areas such as how to use an article purchased, frequently asked questions about an article, cross selling opportunities for vendors and manufacturers, read/post product reviews and free incentive programs. Software, firmware updates and upgrades may also be stored at the post purchase benefits data area 68. At 70 open buyers market data is stored. This is a reverse eBay type model where consumers specify a price they are willing to pay and a date they are desired to obtain an item such that vendors and manufacturers can try to bid for the business of the consumer. At 72 gifting information data is stored which is using the established social network of the provider, members can send gift cards, credits and other earned incentives to others. Additionally, gift trading can be implemented through a market for gift certificates and the like. At 74 real time location based offers may be stored. This is where vendors can communicate to users and others offers and incentives based on proximity to particular store physical locations. This utilizes in part the geolocation and vendor location data stored at 48. At 76 vendor data services are stored. This provides and stores purchase behavior data, lost opportunity data to competitors, incentive market penetration data and provides loyalty incentive data. This vendor data service 76 is similar to the manufacturer data service 60 for manufacturers.

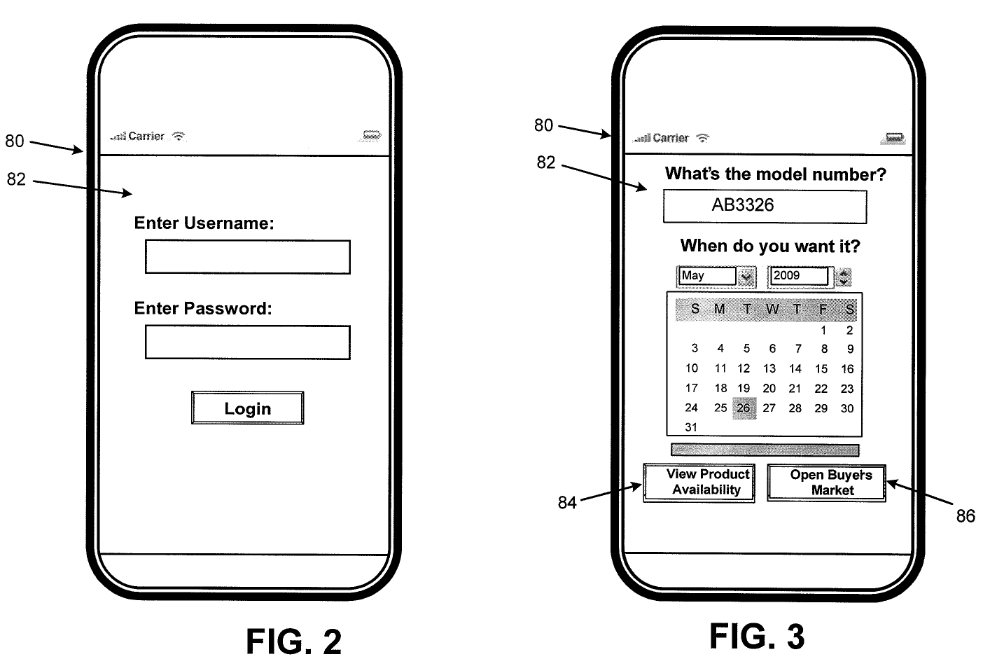

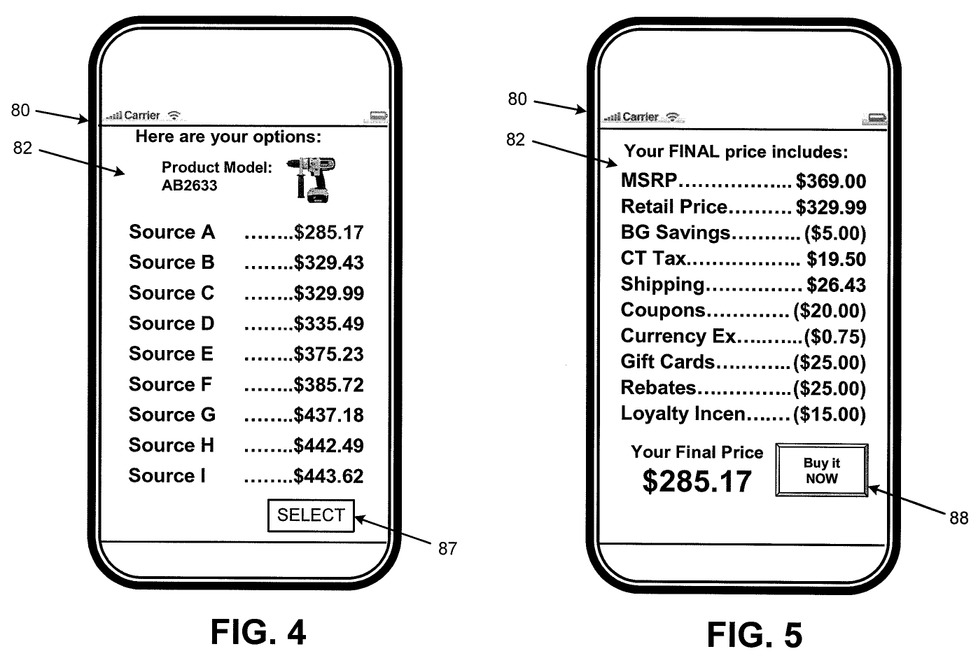

Reference is now made to FIGS. 2-8 which are diagrammatic representations of a device suitable to be used when interconnecting to the system shown in FIGS. 1A and 1B to access and employ various features of the system shown in FIGS. 1A and 1B. The device shown generally at 80 is a web enabled device that allows bidirectional communications between the device and the provider infrastructure 12. The device includes GPS capability and is web enabled to facilitate internet communications. The device further includes a display 82 which displays various data and information as shown in FIGS. 2-8. In FIG. 2 the device illustrates a user name and password employed to sign in to the provider network to enable access. FIG. 3 displays the ability to relate the purchase of a specific model item such as AB3326 displayed on the display 82 for immediate purchase or for purchase at a specific date here shown as May 26, 2009. The device also illustrates the ability to view all of the sources for the particular item available through initiating a soft key 84 or soft key 86 to implement or enter the open buyers market as shown at storage item 70 in the server storage 14. In FIG. 4, various items are shown through the purchased of a specific item here shown as a hammer drill. Accordingly, hammer drill model AB2633 is obtainable on May 26, 2009 from source A, source B, source C, source D, source E, source F, source G, source H and source I. Various different consolidated prices are shown for each of the displayed sources for the hammer drill. The sources can be both vendor stores and online services for the various items. The consolidated prices can include such factors as location, rebates, coupons, loyalty discounts, etc. and the prices all shown as the final prices. As an example, an online vendor with a particular shipping cost would be compared to a particular vendor location or source which required driving including the cost of gas, tolls and other travel expenses to obtain the particular item. Thus, the purchase decision is made based on the preferences of the consumer and disregards the particular source for the various items being obtained, whether it is from a vendor, online source or a mail order catalog. By highlighting Source A and by initiating a soft select key 87, the details of the source A final price are displayed as shown in FIG. 5. Additionally, user specific item data from a specific source could be associated with a particular pricing or procurement terms package in a time-based promotional model or otherwise and could be based upon specific dynamic user location for a mobile user. The authorization may include verifying specific user access to a particular pricing or procurement terms package (price, delivery date, packaging, etc.) based upon specific dynamic user location for a mobile user. The mobile user has a mobile processor 80.

FIG. 5 illustrates the display of the final price of the selected source A. The final price, here shown as $285.17 is shown as being a broken down into retail price of $329.99 a buying group saving of $5.00, a Connecticut tax of $19.50, a shipping cost of $26.43, a coupon value reduction of $20.00, a currency exchange reduction of $0.75, a gift card credit of $25.00, a rebate program of $25.00 and a loyalty incentive program of $15.00. Soft key 88 is provided to implement a purchase. The MSRP (manufacturer's suggested retail price) of $369.00 is also shown.

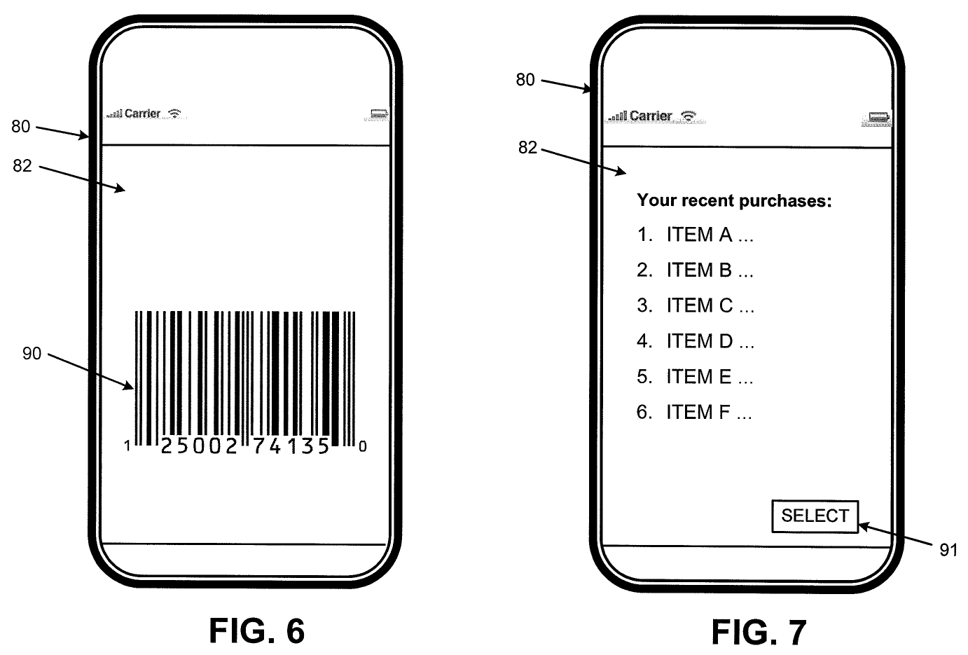

FIG. 6 illustrates a barcode displayed on the web enabled device 80. The barcode 90 or other suitable code is scannable at a point of sale terminal where desired. The barcode on the display can be used for various verification purposes such as verification for authorization to purchase an item from a source at a particular price, to request that an item be retrieved from warehouse for customer pickup, a verification of payment for an item being purchased at a particular source and customer loyalty program identification and other forms of identification. The bar-code generated by the provider infrastructure 12 can function as a secure method of payment at the POS. The system delivers a time-stamped bar-code to be scanned at POS to authorize transactions in the server. The provider infrastructure server then completes the funds exchange after verifying store location. FIG. 7 which shows an example of consolidated information that can be displayed with respect to a number of items purchased by a user. Here, displayed are the user's purchases of item A through item F, numbered 1-6. Each of these items can be individually selected by highlighting the item and by initiating a soft selection key 91 to display more specific information concerning the particular item such as receipts, warranty information, how to information, frequently ask questions about the items, forums about the item, cross-selling availability of related products, and post a review concerning the item or tell-a-friend and obtain credits for the item. Other features and functionalities related to the purchase of particular products or items can be available through the system.

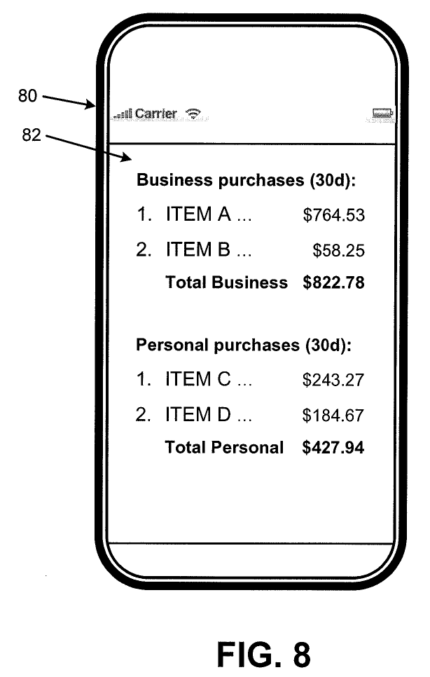

FIG. 8 illustrates the categorization of the purchases into business type purchases and personal type purchases which can be later used for various accounting activities including tax accounting activities. Purchases of items A and B are shown as business purchases while purchases of items C and D are shown as personal purchases. The price and totals for each type of purchases are displayed. Various information can be displayed based on the user preference for the different purchases such as purchase types or other categorization of information such as warranty expiration dates and the like which can be calendared for review.

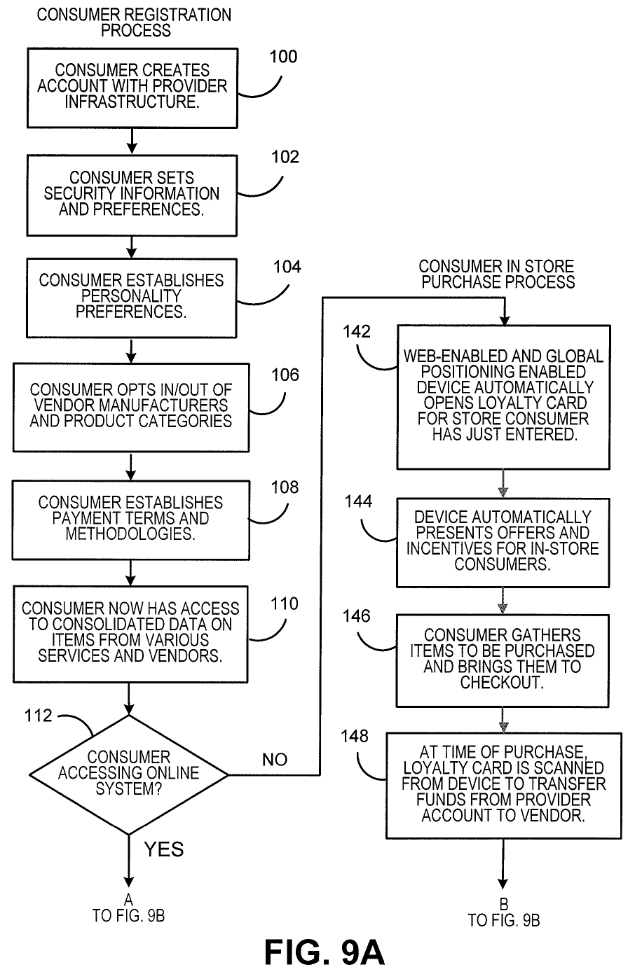

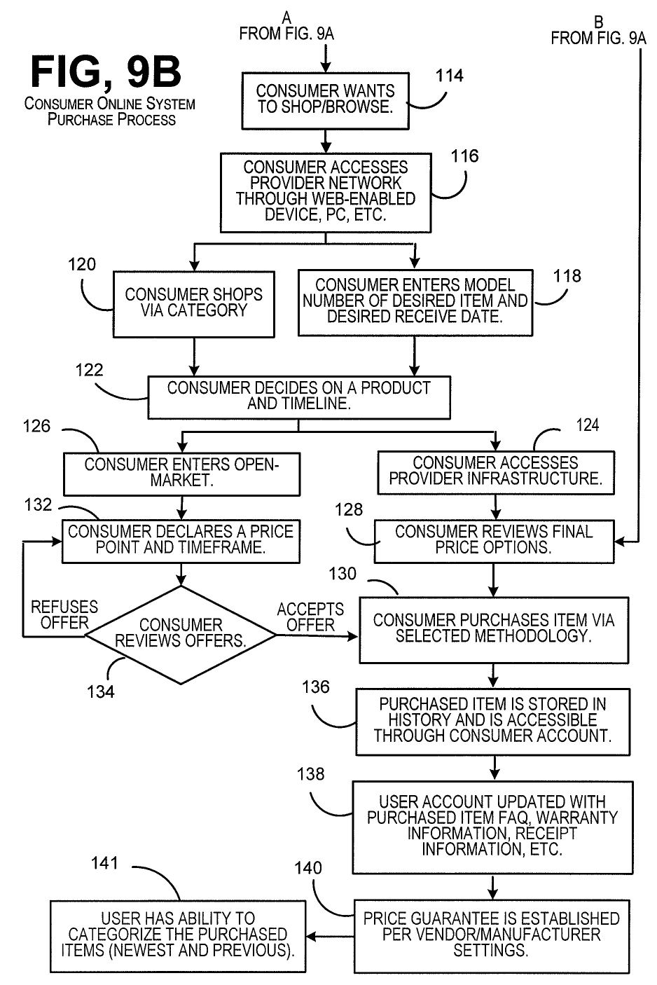

Reference is now made to FIGS. 9A and 9B which is a flow chart of the operation of the system shown in FIGS. 1A and 1B. At block 100 a consumer creates an account with the provider infrastructure. The consumer sets the security information and preferences at block 102 and establishes personality of preferences at block 104. At block 106, the consumer opts-in or opts-out of vendors, manufacturers and product categories to further personalize the operation of their system. At block 108 the consumer establishes payment terms and methodologies and at block 110 the consumer accesses consolidated data on items from various sources. The consolidated data contains information about the source and about the user.

The retrieved consolidated data concerning an item from the provider infrastructure may include a plurality of data elements from each the sources of the item such as price offers, rebates, incentives, discounts and location of the item. The source data elements are data elements that relate to the specific source of the item and can include any type of data element included in determining the cost of the item. The retrieved consolidated data concerning an item from the provider infrastructure may include a plurality of data elements about the user which are specific to each of the of sources of the item. The user data elements are data elements that are specific to the user and can include any type of data element included in determining the cost of the item from the specific source. For example, the user may have a gift certificate applicable to one source of the item and a loyalty card discount applicable to another source of the item. In like manner, buyers' group discounts, tell-a-friend credits, and credit card or other programs of the user may be applicable to different sources. As another example, the location of the item for a particular source and the location of the user may be part of the consolidated data. The consolidated data for each source of the item includes these types of elements which are applicable to the specific source of the item and which are applicable to the specific user.

At decision block 112 a determination is made whether to enter the online system process or implement the in store system process. Where a determination is made at decision block 112 to enter the online system, at block 114 the system is entered by the consumer implementing a shop/browse functionality. The consumer at block 116 accesses the provider network through the web enabled device, PC or other similar device. At block 118, the consumer enters the desired model number of the item and the desired receive date for the item. Alternatively, at block 120, the consumer shops via the various categories for the particular item. In either event, at block 122 the consumer decides on a product and a timeline. At block 124, the consumer accesses the provider infrastructure or alternatively at block 126, the consumer enters the open market, essentially the open buyers market. Where the consumer has accessed the provider infrastructure at block 124, the process continues at block 128 where the consumer reviews final prices and options. At block 130, the consumer purchases the item via the selected methodology.

Where the consumer has entered the open market at block 126, the consumer declares a price point and time frame at block 132 and at decision block 134, the consumer reviews offers and either accepts the offer and the process continues at block 130, or rejects the offers where the process loops back to block 132.

After the consumer purchases the items at block 130, the process then continues at block 136 where the purchased item data is stored in the provider infrastructure history and is thereafter accessible through the consumer account. At block 138 the user account is updated with purchased item frequently asked questions, warranty information, receipt information and other information related to the purchase of the particular item.

Where a price guarantee is provided in accordance the vendor or manufacturer program or setting this is established at block 140. This data is available for later comparison to prices from other sources including the source that provided the item to the consumer or whatever may be required by the price guarantee program. Events can be generated based on the time limits and other parameters of the particular price guarantee program. These events can be communicated back to the consumer, vendor and/or manufacturer for appropriate action. Finally, at block 141, the user has the ability to categorize the purchased item for access and/or viewing such as the newest purchases and previous purchases, personal versus business purchases or based on other criteria established by the consumer.

Where at decision block 112 the consumer has elected to purchase the item in a store, the process continues at block 142. At block 142, where desired, the web enabled and GPS enabled device of the consumer automatically opens any loyalty cards for the particular store the consumer has just entered. The device automatically presents offers and incentives for the in-store consumer at block 144 and at block 146 the consumer gathers items and brings them to the checkout counter POS terminal.

At block 148, at the time of purchase, the loyalty card data displayed on the device is scanned from the device to implement the purchase. The purchase can be as indicated in block 148 or by any selected method, to transfer the funds from the provider account to the vendor. Usually, this will be in accordance with preselected methodologies of the consumer. After block 148, the process continues as previously described at block 128.

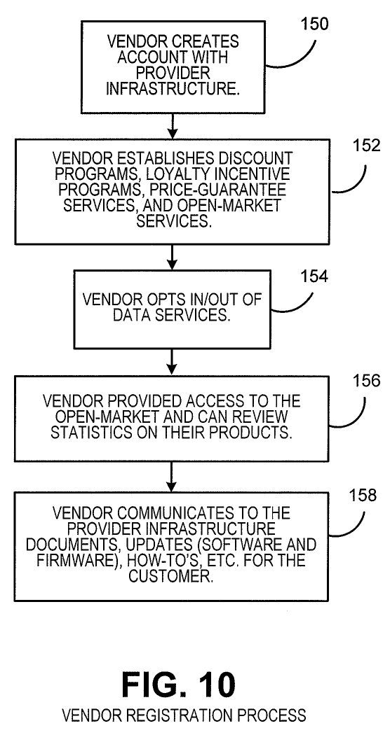

Reference is now made to FIG. 10 which is the flow chart of the vendor registration process. At block 150, the vendor creates an account with the provider infrastructure 12. The vendor establishes discount programs, loyalty incentive programs, price guarantee, services, and open market services and the like at block 152. The vendor thereafter opts-in or opts-out of data services at block 154. At block 156, the vendor is provided access to open market and review statistics on vendor products and other data. At block 158 the vendor's communicates via the provider infrastructure documents, updates such as software, firmware, how-to, etc. for access by the consumer of the vendor products.

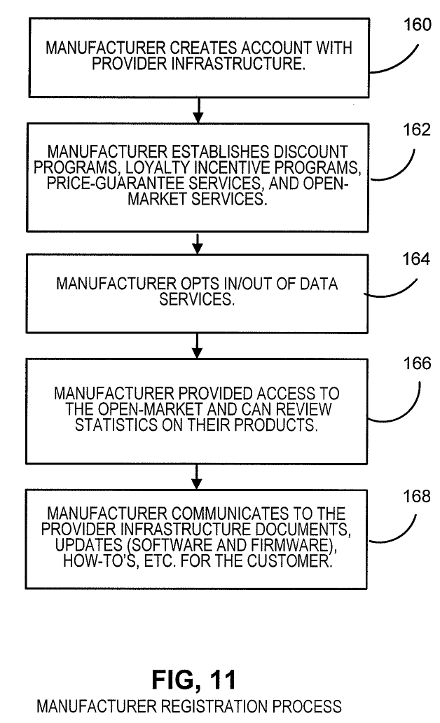

Reference is now made to FIG. 11 which is a flow chart of the manufacturer registration process this process. This process is similar in many respects to the vendor registration process. At block 160, the manufacturer creates an account with the provider infrastructure. At block 162, the manufacturer establishes discount programs, loyalty incentive programs, price guarantees services, open market services and the like. At block 164, manufacturer opts-in or opts-out of various data services. At block 166, the manufacturer is provided access to open market and review statistics on manufacturer products. Finally, at block 168, the manufacturer can communicate via the provider infrastructure documents, updates, such as software, firmware, how-to, etc. for access by the consumer of the manufacturer's products.

The system enables identifying location and deliver by date for items with specific pricing for items sold by various vendors (physical locations and online). This includes item price (in local currency), ability to lock-in foreign exchange rate, rebates, coupons, gift cards, loyalty incentives, shipping, tariffs, taxes, and other fees. Moreover, consumers can specify, a user's personal information such as physical address, e-mail address, phone, text messages, credit cards, etc. These can be consolidated via the provider infrastructure to one centralized account and users can opt-in and opt-out of receiving communications such as offers, advertisements, etc. for any vendor in the system. Additionally, any changes to personal information are transparent to vendors.

The system via the provider infrastructure generated bar or other type code facilitates payment and efficiency in processing transactions. Purchase related information such as warranty details, receipts, rebates, loyalty incentives, cross-selling related items are tracked and consolidated. Personal and business-related purchases and related taxes are organized for separate tracking as is warranty and price guarantee programs. By employing the system, users can now make better purchasing decision based on consolidated data and vendors and manufacturers can access global purchase information database for buying trends and increased security is provided at the POS operations. Additional or different types of user, vendor and manufacturer data can be stored in the server storage 14 can consolidated for use by various interconnected networks.

While the present invention has been disclosed and described with reference to a single embodiment thereof, it will be apparent, as noted above, many variations and modifications may be made therein. It is, thus, intended in the following claims to cover each variation and modification that falls within the true spirit and scope of the present invention.

What is claimed is:

1. A method for obtaining an item, comprising the steps of:
retrieving consolidated data concerning an item from a provider infrastructure, said consolidated data including data elements from a source of said item with procurement terms and data elements concerning a mobile user of said provider infrastructure;
retrieving verifiable authorization from said provider infrastructure for said mobile user of said provider infrastructure to obtain said item from said source of said item according to the procurement terms and consistent with said consolidated data;
and,
displaying on a device said verifiable authorization from said provider infrastructure for said mobile user of said provider infrastructure to obtain said item from said source consistent with said consolidated data, wherein said authorization is based at least in part upon the recent location of the mobile user.

2. The method for obtaining an item as defined in claim 1 comprising the further steps of:
retrieving payment verification from said provider infrastructure for said item from said source of said item consistent with said consolidated data by a preselected method of payment by said mobile user of said provider infrastructure; and,
updating said provider infrastructure with data related to said mobile user of said provider infrastructure and said source of said item.

3. The method for obtaining an item as defined in claim 2 wherein said step of retrieving consolidated data concerning an item includes retrieving consolidated data from each of a plurality of sources of said item.

4. The method for obtaining an item as defined in claim 3 wherein said step of retrieving consolidated data concerning an item includes retrieving consolidated data elements concerning said the mobile user of said provider infrastructure for each of said plurality of sources of said item.

5. The method for obtaining an item as defined in claim 2 wherein said payment verification provides confirmation of payment to said source of said item by said mobile user of said provider infrastructure for said item.

6. The method for obtaining an item as defined in claim 4 comprising the further step of displaying on a device in a machine readable format said verifiable authorization from said provider infrastructure for said mobile user of said provider infrastructure to obtain said item from said source of said item consistent with said consolidated data.

7. The method for obtaining an item as defined in claim 6 comprising the further step of said source of said item scanning said displayed verifiable authorization from said provider infrastructure for said mobile user of said provider infrastructure to obtain said item from said source of said item consistent with said consolidated data.

8. The method for obtaining an item as defined in claim 7 comprising the further step of displaying on a device in a machine readable format said payment verification for said item from said source of said item consistent with said consolidated data by a preselected method of payment by said mobile user of said provider infrastructure.

9. The method for obtaining an item form a source as defined in claim 8 comprising the further step of said source of said item scanning said displayed payment verification for said item from said source consistent with said consolidated data by said preselected method of payment by said mobile user of said provider infrastructure.

10. The method for obtaining an item as defined in claim 4 wherein said retrieved consolidated data concerning an item from a provider infrastructure includes data elements related to the global position location of said source of said item.

11. The method for obtaining an item as defined in claim 4 wherein said retrieved consolidated data concerning an item from said provider infrastructure includes a plurality of data elements of said mobile user of said provider infrastructure for each of said plurality of sources of said item.

12. The method for obtaining an item as defined in claim 11 wherein said plurality of data elements of said mobile user of said provider infrastructure for each of said plurality of sources of said item includes one or more of loyalty program data, gift card data, store credit data, and coupon data.

13. The method for obtaining an item as defined in claim 4 wherein said retrieved consolidated data concerning an item from a provider infrastructure includes manufacturer incentive data for purchase of said item by said mobile user of said provider infrastructure.

14. The method for obtaining an item as defined in claim 4 wherein said retrieved consolidated data concerning an item from a provider infrastructure is based on a date communicated to said provider infrastructure by said mobile user of said provider infrastructure as to when said item is to be obtained.

15. The method for obtaining an item as defined in claim 4 wherein said provider infrastructure stores warranty data for said item purchased by said mobile user of said provider infrastructure from said source of said item.

16. The method for obtaining an item as defined in claim 4 wherein said provider infrastructure stores price guarantee data for said item purchased from said source of said item by said mobile user of said provider infrastructure.

17. The method for obtaining an item as defined in claim 4 wherein said provider infrastructure stores price guarantee data for said item purchased from said source of said item by said mobile user of said provider infrastructure and including the further steps of comparing price availability from a plurality of sources of said item related to said price guarantee data for said item purchased from said source of said item.

18. The method for obtaining an item as defined in claim 17 including the further steps of notifying said mobile user of said provider infrastructure when said step of comparing price availability from a plurality of sources of said item related to said price guarantee data for said item purchased from said source of said item determines the occurrence of an event within parameters of said price guarantee data for said item purchased from said source of said item.

19. The method for obtaining an item as defined in claim 4 including the further steps of consolidating and storing in said provider infrastructure manufacturer and vendor offers accessed by said mobile user of said provider infrastructure.

20. A system for obtaining an item, comprising:
a provider infrastructure including a server and associated server memory having stored therein data elements relating to a source of an item and data elements relating to a user of said provider infrastructure, and operable to consolidate data stored therein, said consolidated data including data elements from a source of said item and data elements concerning a user of said provider infrastructure;
a bidirectional communications link connecting said provider infrastructure and said user of said provider infrastructure;
a bidirectional communications link connecting said provider infrastructure and said source of said item;
said provider infrastructure operable to generate verifiable authorization for said user of said provider infrastructure to obtain said item from said source of said item consistent with said consolidated data; and,
said provider infrastructure operable to communicate to said user of said provider infrastructure over said bidirectional communications link connecting said provider infrastructure and said user of said provider infrastructure said verifiable authorization for said user of said provider infrastructure to obtain said item from said source of said item consistent with said consolidated data.
